(19) United States
(12) Patent Application Publication
(10) Pub. No.: US 2019/0335676 A1
(43) Pub. Date: Nov. 7, 2019

(54) SYSTEMS, METHODS AND APPARATUS FOR OPTIMAL GROWTH OF PLANTS

(71) Applicant: CONCEPTS TO SOLUTIONS INC., Oro Medonte (CA)

(72) Inventors: John Vernon Solomon, Oro Medonte (CA); Forrest C. Curry, Barrie (CA); Rod Groves, Orillia (CA); Brandon B. Phillips, Barrie (CA); Mitchell Quathamer, Parry Sound (CA); Thomas Ring, Barrie (CA); Aaron Styles, Hillsdale (CA); John Rydall, Oakville (CA); John R. White, Barrie (CA)

(73) Assignee: CONCEPTS TO SOLUTIONS INC., Oro Medonte (CA)

(21) Appl. No.: 16/405,271

(22) Filed: May 7, 2019

Related U.S. Application Data
(60) Provisional application No. 62/667,861, filed on May 7, 2018.

(51) Int. Cl. A01G 7/04; A01G 15/00; A01G 9/14; A01G 9/24

(52) U.S. Cl. CPC A01G 7/045; A01G 9/24; A01G 9/14; A01G 15/00

(57) ABSTRACT

The present invention relates to systems, methods and apparatus for multi-dimensional conveyor which allows for the planting, growing and harvesting of plants and plant material in a manner which optimizes yield, allows for consistency, allows production and harvesting to be automated, and allows production to proceed in conditions which may be most favorable to biologic activities associated with plant products. The entire apparatus can be constructed of lightweight, cost-effective materials, which afford mass-production and mass-array into vast automatic growing operations.

### FIELD OF INVENTION

The present invention relates to systems, methods and apparatus for multi-dimensional conveyor which allows for the planting, growing and harvesting of plants and plant material in a manner which optimizes yield, allows for consistency, allows production to be automated, and allows production to proceed in conditions which may be most favourable to product biologic activities associated with plants and/or plant products. The apparatus can be constructed of lightweight, cost-effective materials, which afford mass-production and mass-array into vast automatic growing operations.

### BACKGROUND TO THE INVENTION

With many jurisdictions decriminalizing the use of cannabis (C. sativa), there has been more interest in cultivating this crop. Artificial grow rooms and greenhouses have been and are starting to be used in the production of cannabis. Growing cannabis in artificial grow rooms and/or greenhouse allows for more controlled growth conditions which is safer, more predictable and easier than growing outdoors. Greenhouses offer protection from the elements and provide a longer growing season, allowing growers in northern regions the ability to grow crops either with traditional clones or from seeds. Mother nature and a Greenhouse add complexity to being able to control a critical precise environment

The growth and maturation of many plant crops, particularly cannabis, require very specific conditions to optimize the grow conditions for each particular strain or variant of the plant. There is a need at present for the large scale production of such plants both to supply emerging food and energy markets and to offset impacts to food supplies and land usage created by the increasing usage of traditional food sources as fuel and the increasing global populations placing pressures on food, water, fuel stocks, land and other resources. There is also greater demand for consistency as medical therapies using cannabis products require consistency of efficacious ingredients. Prior inventions had addressed portions of the needs far automated or high-density production of crops for food and biomass, but had not addressed these optimal characteristics.

There is also a need to be able to harvest the plants with minimal disturbance to the plants and to the people tasked with harvesting the plants or parts thereof. In order to substantially increase the production of food and other material, there is a need to fully automate farm production, as well as to produce crops within optimized structures. In addition to increasing the speed of production, increasing the speed of harvest, and reducing labor and materials costs, automation will allow the growth of plants in conditions which may be optimal for plants, such as optimal ratios between O₂ and CO₂, lighting, temperature, nutrient chemicals, temperature humidity, Vapor Pressure Deficit etc.

Previous inventions have failed to address these concerns. Not surprisingly, a number of patent references disclose aspects of the plant production, namely systems and methods for automating the growth and maturation of plants within climate controlled environments. For example, U.S. Patent Application No. 20170094920 teaches incubation and cultivation system for regulated plant growth. U.S. Pat. No. 8,533,993 teaches a horizontal and vertical continuous loop “zig zag” conveyor system for cultivating plants (e.g. potted sugar cane, corn, sorghum, etc.). In the conveyor, young plants start on the framework at the beginning of a lower, horizontal traverse than travel across the lower, horizontal traverse, where they ascend the conveyor along the reversing traverses and helical path of a vertical column on the framework as they mature into adolescent plants, the adolescent plants cross over along an upper, horizontal traverse on the framework to a second vertical column on the framework, where they descend the conveyor along the reversing traverses and helical path of the second vertical column until they reach final maturation at the starting position, where they may be harvested. International Patent Publication No. WO2014066844A2. The '844 Publication teaches a system that includes an enclosed space defining a controllable environment chamber. The system also includes at least one monitoring device configured to measure multiple characteristics of an environment within the chamber. The system further includes multiple actuators configured to alter the characteristics of the environment within the chamber. The enclosed space includes at, least one rack system configured to be placed within the enclosed space. Each rack system includes multiple layers configured to receive multiple plants to be grown in the chamber. The actuators may be configured to adjust the characteristics of the environment within the chamber to condition the environment based on the plants to be grown in the chamber. U.S. Patent Application No. US2012054061 teaches system for growing produce having an insulated enclosure housing having a heating, ventilation, and air conditioning (“HVAC”) system that maintains a positive air pressure within the enclosure, at least one non-compartmentalized growing tray, at least one production lane comprising at least one gravity feed growing rack and at least one watering station, wherein the gravity feed growing rack advances the growing tray along the production lane toward the watering station.

There, remains, however, a need for an automated multi-dimensional, multi-tiered conveyor system, apparatus, method and workflows that can be adjusted based on the nutrient and growth requirements of the plants for optimal growth.

### SUMMARY OF THE INVENTION

Accordingly, it is an object of this invention to at least partially overcome some of the disadvantages of the prior art.

The present invention is directed to systems, apparatuses and methods for automating the growth and maturation of plants, particularly cannabis, or plant material to optimize inputs, growing time, potency, etc.

Embodiments of the present invention may be directed to an apparatus and/or system which comprises, among other things, one or more grow tunnels which provide continuous-loop multidimensional conveyors for plants, crops, etc., particularly cannabis. The embodiments of the present invention, including, but not limited to, grow tunnel designs, allows optimal, high-density growth of plants, and affords optimal growth parameters for plants which also allows for easy harvesting by workers or other personal. Individual plants may move through or can be moved through the grow tunnel along different vertical layers and/or horizontal sections or “zones” during growth in a manner which optimizes the growth and production of the plants and biologically active ingredients associated therewith.

An embodiment of the present invention provides a plurality of movable tiers within the grow tunnel, each tier having a plurality of plants disposed therein, and each tier having separate climate controls (for light, humidity, etc.) such that a plurality of growing environments may be provided within the growing apparatus. The method, system and apparatus of the embodiments of the present invention, includes climate controlled multi-tier “grow tunnels” wherein the tiers move through the grow tunnel, each tier having, a plurality of plants disposed therein and, each tier having separate climate controls or zones as noted herein. Within the grow tunnel, there may be provided sensors that measure a variety of growth and production parameters, conditions, variables, etc. for integration into an optimized plant yield plan, process. or operation. The stability and monitoring of the environmental conditions within the grow tunnel allows for energy efficient control of a precision environment. The embodiment of the present invention also provides an access point providing an operator with access to the plants as they move through the growing apparatus.

In operation, the embodiments of the present invention allow for precision climate and artificial daylight conditions as required by the plant (e.g. cannabis) and the ability to monitor all grow related parameters which, in a preferred embodiment, can be used to analyze the specific growth data and parameters so as to optimize the specific growth conditions (e.g. a growth recipe) for the plant depending on type, strain and other factors.

An embodiment of the present invention is directed to an apparatus for optimizing the growth of a plant, the apparatus comprising: (a) a climate controlled grow tunnel having a plurality of tiers, each tier having a plurality of plants disposed therein, each tier having separate climate controls such that a plurality of growing environments or zones is provided within the growing apparatus; and (b) at least one access point providing an operator with access to the plurality of plants as they move through the growing apparatus.

Another embodiment of the present invention wherein the plants move horizontally through each tier and vertically between tiers.

Another embodiment of the present invention provides that the apparatus further comprises a first tier which provides the plant with constant light and a second tier that provides the plant with constant dark.

In yet another embodiment, the apparatus of claim 3 wherein the grow tunnel provides that the plant is exposed to 18 hrs. of light in the first tier, and 6 hrs. of darkness in the second tier.

In yet another embodiment, the apparatus of claim 3 wherein the grow tunnel provides that the plant is exposed to 12 hrs. of light in the first tier and 12 hrs. of darkness in the second tier.

In yet another preferred embodiment, the apparatus of claim 5 wherein the first and second tier conditions may be set at (a) a temperature range of 20° C.-25° C.; and (b) a humidity range of 50-65% R.H., each for two to three weeks before heading to flower.

### BRIEF DESCRIPTION OF THE DRAWINGS

In the drawings, which illustrate embodiments of the invention:

FIGS. 1 to 9 provide, preferred embodiments of the present invention.

### DESCRIPTION OF THE PREFERRED EMBODIMENTS

The description that follows, and the embodiments described therein, is provided by way of illustration of an example, or examples, of particular embodiments of the principles and aspects of the present invention. These examples are provided for the purposes of explanation, and not of limitation, of those principles and of the invention.

It should also be appreciated that the present invention can be implemented in numerous ways, including as a process, an apparatus, a system, a device or a method. In this specification, these implementations, or any other form that the invention may take, may be referred to as processes. In general, the order of the steps of the disclosed processes may be altered within the scope of the invention. The description that follows, and the embodiments described therein, is provided by way of illustration of an example, or examples, of particular embodiments of the principles and aspects of the present invention. These examples are provided for the purposes of explanation, and not of limitation, of those principles and of the invention,

It will be understood by a person skilled in the relevant art that in different geographical regions and jurisdictions these terms and definitions used herein may be given different names, but relate to the same respective systems.

The growth and maturation of particular plant crops, particularly cannabis, may require very specific parameters, conditions, etc. to optimize the grow conditions for each particular strain or variant of the plant as well as the physical, biological and biochemical properties and profiles of the plant as well as compounds that may be harvested from the plants. Embodiments of the present invention are directed to systems, apparatuses and methods for automating the growth and maturation of plants, particularly cannabis, to optimize inputs, growing time, potency, etc.

The present invention is directed to a growing apparatus for growing plants, particularly cannabis, comprising; (a) a climate controlled grow tunnel having a plurality of movable tiers, each tier having a plurality of plants disposed therein, each tier having separate climate controls such that a plurality of growing environments is provided within the growing apparatus; and (b) at least one access point providing an operator with access to the plurality of plants as they move through the growing apparatus.

Embodiments of the present invention can maintain precision climate and artificial daylight conditions as required by the plant and has the ability to monitor all grow related parameters which, in a preferred embodiment, can be used to analyze the specific growth data and parameters so as to optimize the specific growth conditions (e.g. a growth recipe) for the plant depending on type, strain, desired production result and other factors.

The present invention allows the automation of: (a) the plant delivery at the access point of the system for maintenance (e.g. trimming and inspection) on a timed interval basis which allows efficient utilization of personnel; (b) the reduction of cross contamination from personnel in the grow operation; (c) the optimization of building space and resources (e.g. heating, cooling, electricity costs, etc.); (d) the stability of the environmental conditions within the grow tunnel allowing energy efficient control of a precision environment; and (e) the ability to measure by multiple sensor and/or sensory arrays all conditions applicable to the monitoring and integration into an optimized plant yield plan, process, or operation.

The invention provides the ability to control the environmental growing conditions, including temperature, humidity, pressure O₂/CO₂ concentration, etc. relative to the surrounding zone to control odor and the utility costs associated with a precision grow operation. The invention provides the ability to monitor and automatically adjust many factors, including but not limited to Temperature, Humidity, CO₂%, O₂%, Real time measurement of viable and non-viable contamination, etc. Other key factors include, Vapor Pressure Deficit in the chamber for calculation of Temperature/Humidity set-point, Nutrient input composition and flow measurement, Nutrient waste composition and flow measurement for measuring plant uptake of nutrients, Plant leaf color, with comparison to Light intensity sensor, at various levels within the plant canopy. Distance from canopy height to light source, Plant Root Humidity and Temperature, weight of the plant during the grow cycle, etc.

The embodiments of the present invention also provide the ability to mitigate odor and noise production. There may also be provided the ability to control the irrigation/fertilization requirements, and the impact on over/under irrigation, including standing water and its impact on contamination control. More particularly, the embodiments of the present invention provide the ability to reduce contamination during inspection and harvesting/maintenance. The embodiments of the present mention also allow operators to detect and control pests and contamination, such as mold and other diseases, parasites, insects, animals, etc., effectively and efficiently without the use of pesticides and other undesired chemicals.

The embodiments of the present invention also minimize the labor required to handle, monitor, maintain and harvest the plants. The environmental mixed load conditions of a grow room which have a day and night condition, may: (a) cause equipment meant to control the environment to be subject to significant fluctuations in load conditions: and (b) the fluctuation resulting in a difficulty maintaining precision control of the conditions that affect growth. The present invention allows access to the plants or plant material and provides the necessary infrastructure components to precisely control the temperature humidity and other controlled conditions affecting the environment.

The embodiments of the present invention provide the ability to track each plant from seed or clone to harvest, including the ability to track input (e.g. water, light, nutrients, plus others etc.) on a per plant basis. The invention also provides that ability to maintain a consistent height of the light source from the canopy height. In a preferred embodiment, female plants may be required to produce the high value flower that is used to either smoke/vape/concentrate. Cannabis growth can be started one of two ways: Seed or Clone. In Seed, the seed is germinated and then kept in a high humidity, bright, and warm (21° C.-23° C.) environment to start growth. The plant is then grown to a similar size as a clone. Seeds can be either male or female and need to be sexed during the vegetation/flower stage to identify and remove the males. If there are any male plants in the room with the females, the crop will be lost. The females will produce seeds and not the high value flowers.

In clone propagation, a branch—with leaves—is taken from a mother plant. The mother plant is known to be a good producer of the strain/strength required. Mother plants may be all female, hence all cuttings/clones from the plant will be female. Once a clone, or seed, is large enough; has at least two or three serrated leaves, and can support itself, it's moved to a vegetative room/state. In the vegetation state, the room conditions may be changed to an 18 hr on/6 hrs off lighting period (referred to as a “photoperiod”), and 20° C.-25° Cc. temperature range with 50-65% humidity, for two -three weeks before heading to flower. This is done to stimulate fan leaf growth, which allows the plant to gather the required light energy for growth. Night time temperatures should be 5° C.-8° C. (no more than 10° C.) cooler than day temperatures. A slight breeze is introduced to facilitate strong stalk growth. This air movement will continue during the flowering stage. Once in flower, the light period changes to 12 hrs on/12 hrs off to simulate fall conditions that cause the plant to go into flower (bloom) phase. The flower phase can be from 8-12 weeks depending on strain and room conditions. Generally, 18° C.-26° C. temperature range is needed with 40-55% humidity. Some strains may want it warmer or cooler. Night time temperatures should be 5° C.-8° C. (no more than 10° C.) cooler than day temperatures. The master grower will determine what is required for their plants.

The embodiments of the present invention are directed to a growing apparatus for growing plants, particularly cannabis, comprising: (a) a climate controlled grow tunnel having a plurality of movable tiers, each tier having a plurality of plants disposed therein, each tier having separate climate controls such that a plurality of growing environments is provided within the growing, apparatus: and (b) at least one access point providing an operator with access to the plurality of plants as they move through the growing apparatus.

The embodiments of the present invention maintain precision climate and artificial daylight conditions as required by the plant and the ability to monitor all grow related parameters which, in a preferred embodiment, can be used to analyze the specific growth data and parameters so as to optimize the specific growth conditions (e.g. a growth recipe) for the plant depending on type, strain and other factors.

The present invention allows the automation of: (a) the plant delivery at the access point of the system for maintenance (e.g. trimming and inspection) on a timed interval basis which allows efficient utilization of personnel; (b) the reduction of cross contamination from personnel in the grow operation; (c) the optimization of building space and resources (e.g. heating, cooling, electricity costs, etc.); (d) the stability of the environmental conditions within the grow tunnel allowing energy efficient control of a precision environment; and (e) the ability to measure by multiple sensor arrays all conditions applicable to the monitoring and integration into an optimized plant yield plan, process, or operation.

Preferred embodiments of the present invention can be implemented in numerous configurations depending on implementation choices based upon the principles described herein. Various specific aspects may be disclosed. which may be illustrative embodiments not to be construed as limiting the scope of the disclosure. Although the present specification describes components and functions implemented in the embodiments with reference to standards and protocols known to a person skilled in the art, the present disclosures as well as the embodiments of the present invention are not limited to any specific standard or protocol.

Some portion of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. may be here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

Embodiments of the present invention can be implemented by a software program for processing data through one or more devices (e.g. computer system). It will be understood by a person skilled in the relevant art that the computer system can be any device (e.g. personal computer, mobile device, notebook computer, server computer, mainframe, networked computer (e.g., router), workstation. software application and the like). The program or its corresponding hardware implementation is operable for providing user authentication and authorization. In one embodiment, the computer system includes a processor coupled, to a bus and memory storage coupled to the bus. The memory storage can be volatile or non-volatile (i.e. transitory or non-transitory) and can include removable storage media. The computer can also include a display, provision for data input and output, etc. as will be understood by a person skilled in the relevant art.

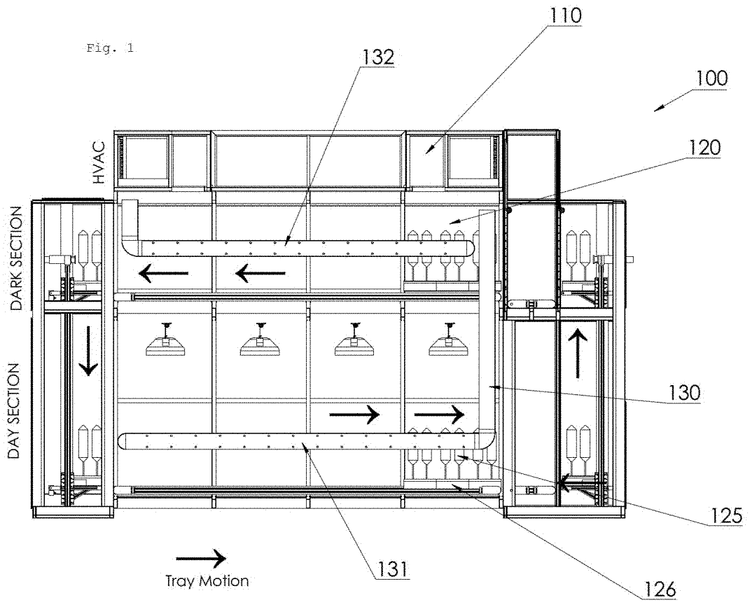

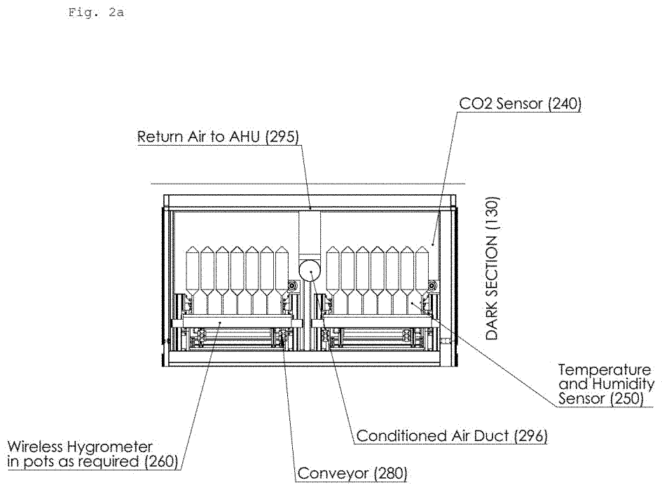

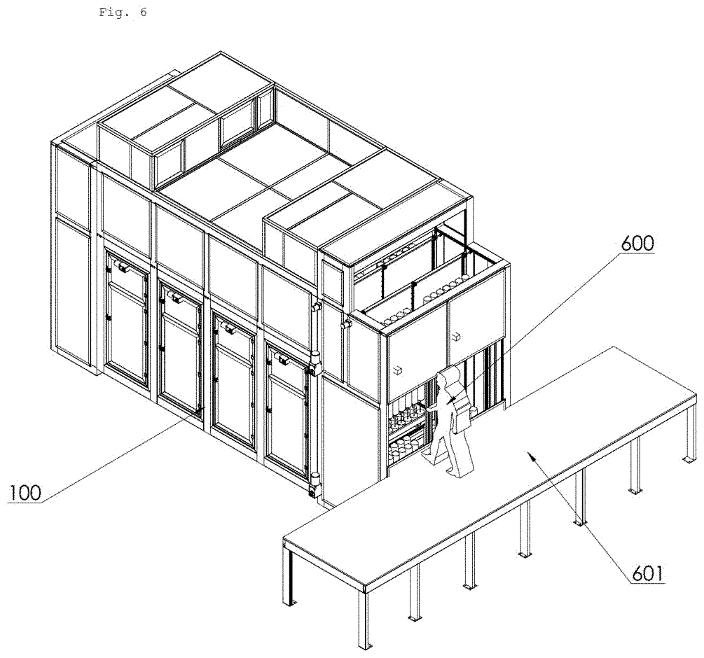

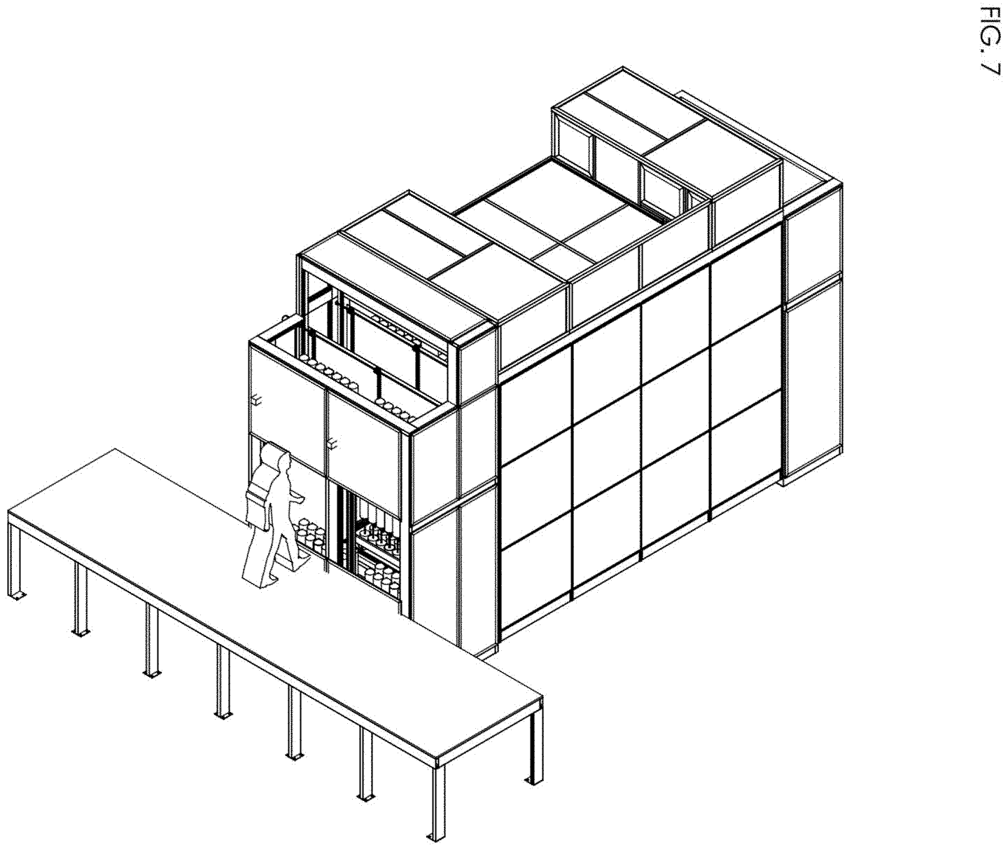

Preferred embodiments are provided in FIGS. 1 to 9. As shown in FIG. 1, there is provided a grow tunnel 100 having at least two grow “zones” 120 and 130 and an area for equipment 110 (such as heating. ventilation, and air conditioning (“HVAC”). In a preferred embodiment, area 110 houses the HVAC systems and other equipment necessary to run the controlled environments of zones 120 and 130. A person skilled in the relevant art will understand that the HVAC and lighting systems of the present invention may be standard systems and equipments for use in plant growing operations. In one embodiment as shown in FIGS. 7, 9 and 10, the first grow zone 130 can be referred to as the lower, day section (when the plants may be present in this lower day zone they may be said to be in the “day cycle”) where the plants may be exposed to light while growing according to prescribed conditions. The second grow zone 120 can be referred to as the middle, dark section where the plants may be maintained in darkness according to prescribed conditions (when the plants may be present in this middle dark zone they may be said to be in the “night cycle”). It will be understood that plants, particularly cannabis, require specific conditions to light and darkness in order to achieve optimal growth. The service access port for workers (see, for example, 600 on platform 601 in FIG. 6) to access the plants can be provided on one or both ends of the tunnel depending on length.

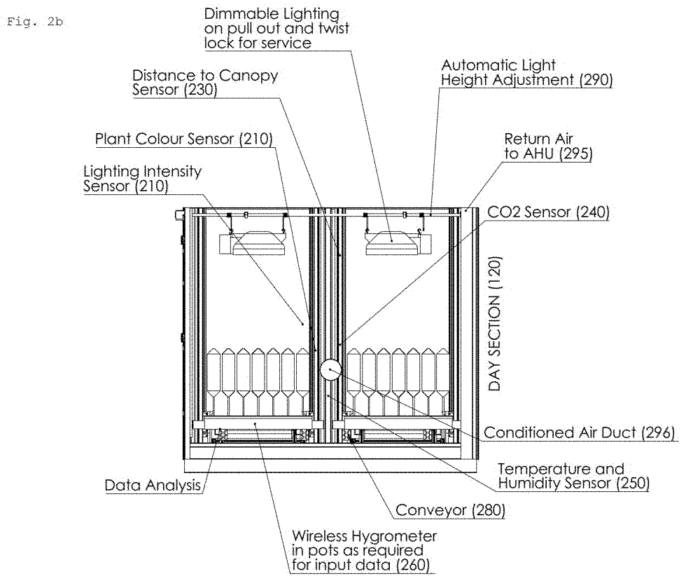

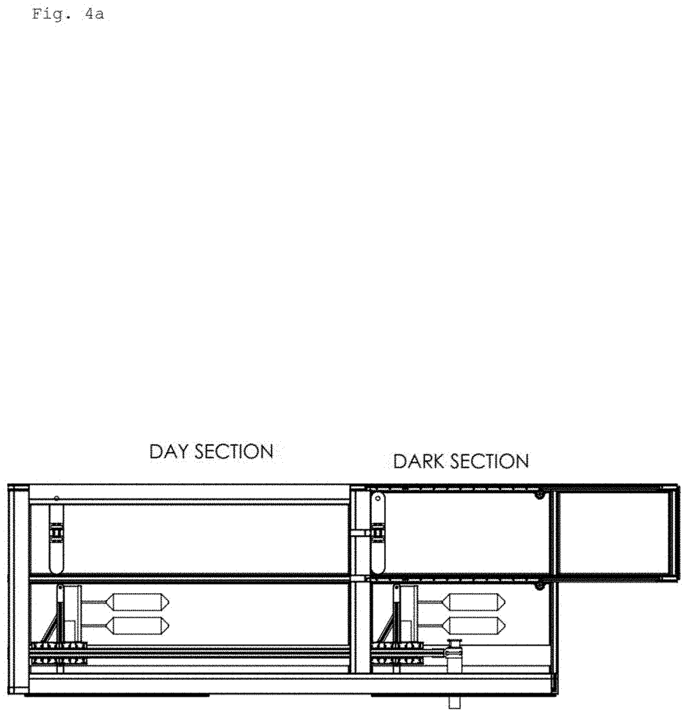

It will be understood by a person skilled in the relevant art that the orientation of the day and dark sections (and day and dark cycles) can be reversed. In a preferred embodiment as shown in FIGS. 1, 2a and 2b, the first grow zone 130 can be referred to as the day section (when the plants or plant material 125 may be present in this lower day zone they may be said to be in the “day cycle”) where plants 125 (located in movable trays 126) may be maintained in the zone with exposure to light while growing according to prescribed conditions. The second grow zone 120 can be referred to as the middle, dark section where plants 125 may be exposed to dark according to prescribed conditions (when the plants or plant material may be present in this middle dark zone they may be said to be in the “dark cycle”). As shown in the preferred embodiment of FIG. 1, area 110 houses the HVAC systems and other equipment necessary to maintain the temperature conditions of the zones 120 and 130. As shown in FIG. 1, there is also vent action ducts provided through the day section (ventilation apparatus 131) and through the dark section (ventilation apparatus 132). In a preferred embodiment, ventilation apparatus 131 and 132 provide for air flow and ventilation specific to the day and dark zones (see FIG, 5). There is also provided two end sections (see FIGS. 4a and 4b) which provide elevation apparatus that moves the tray/plant combinations between the dark zone and the day zone. It will be understood by a person skilled in the relevant art that such equipment is standard and well know in the industry. One of the end sections or portions can be referred as as the “presentation section” or “presentation zone” (see FIG. 4a) which can allow workers (see for example 600 in FIG. 6) the ability to inspect the plants 125 and/or work on the plants (e.g. take cuttings, trim plants, harvest, inspect for pests, etc.) (see FIGS. and 7). The end of the apparatus which contains the presentation zone is typically referred to as the “presentation end”.

As can be seen in FIG. 1, preferred embodiments of the present invention provide for allowing trays 126 containing plants or plant material 125 to cycle through the dark and day sections. As shown in FIG. 1, the combined trays and plants circulate in a counterclockwise fashion, However, it will be understood by a person skilled in the relevant art that the tray/plant combination could move through the zones in a clockwise fashion. In a preferred embodiment, each tray/plant combination will cycle through the entire apparatus on a 24 hours basis. It will be understood by a person skilled in the relevant art that each tray/plant combination may not cycle equally between the dark and the day zones. More specifically, it will be understood that the tray/plant combinations could spend unequal amounts of time in each section, depending on the desired requirements or conditions for optimal growth.

FIGS. 2(a) and (b) shows another view of the preferred embodiment of FIG. 1 with both zones 120 (FIGS. 2(b)) and 130 (FIG. 2(a)). There may be a number of environmental sensors disposed within each zone, including lighting intensity sensors 210, plant color sensor 220, distance to canopy senor 230, CO₂ sensors 240, temperature/humidity sensor 250. and in pot hygrometer 260. It will be understood that a similar configuration can be provided for the preferred embodiments provided in FIGS. 6 to 9 (not shown). There may also be provided irrigation system (e.g. drip irrigation) that controls the degree to which the plants may be watered. It will be understood that this is only one possible configuration (with varying types) of environmental sensors. The zones may be also provided with variable motion conveyor systems that allow or pass the plants through the zones in accordance with preset optimal growth conditions. In a preferred embodiment, there may be provided adjustable lighting or light fixtures 290 to maintain the ideal lighting conditions for the canopy in the day cycle. In a further preferred embodiment, there is provided a return air to AHU 295 adjusted across the ceiling with an upward laminar flow with membrane filtration. In a preferred embodiment, there may also be provided conditioned air nozzles 296 for adjustment horizontally and vertically with internal baffles.

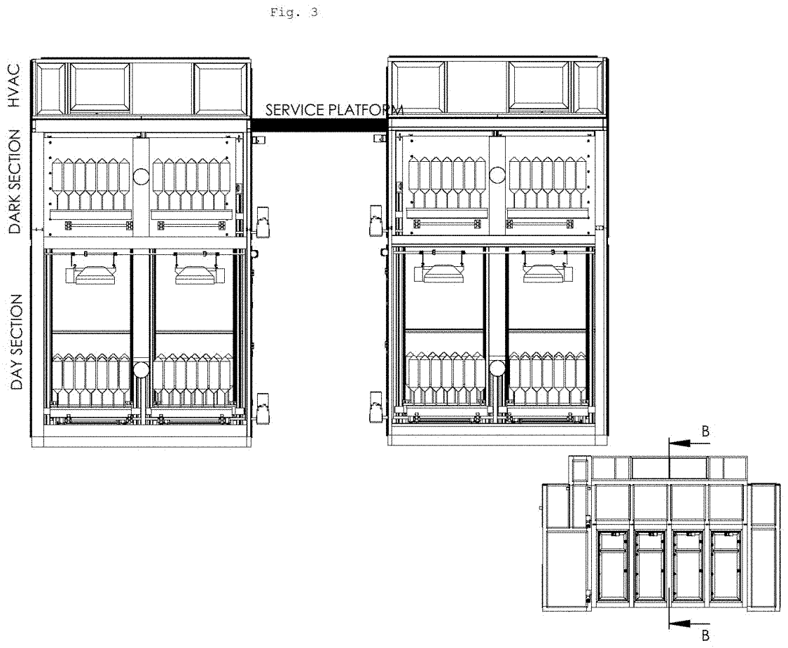

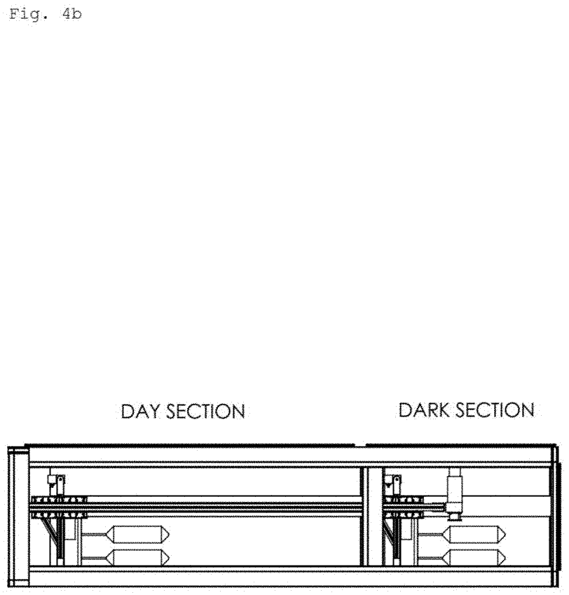

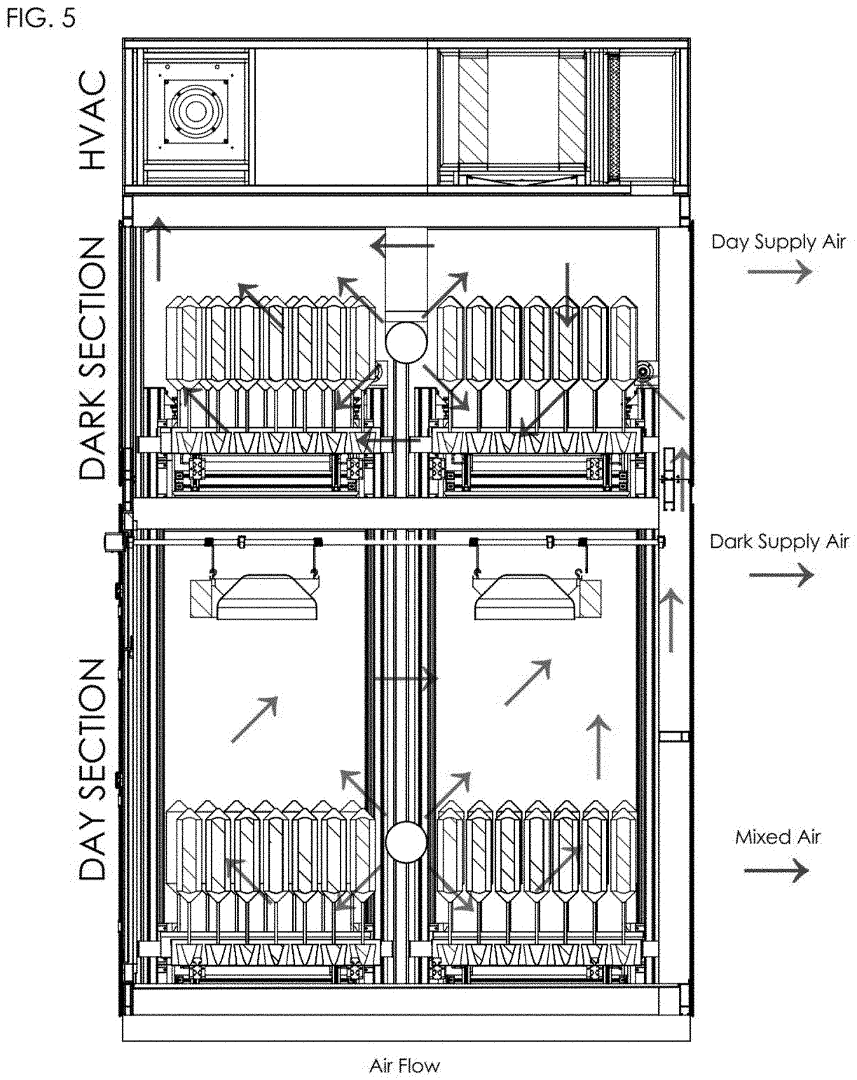

A preferred embodiment is shown in FIG. 3 which provides for multiple units 100 that may be linked by a service platform. As can be seen in FIG. 3, the units may be set up as mirror images of each other. FIG. 5 shows the air flow within the day and dark sections via ventilation ducts 131 and 132. Ventilation duct 131 provides air to the day section (“day supply air) while ventilation duct provides air to the dark section (“dark supply air”). Given the differing growing conditions in the two section, a preferred embodiment of the invention provides for separate air flow in the the two sections. It will be understood however, that air from one section may mix with air of another section. As seen in FIG. 5, the air supply from the day section may mix with air from the dark section, which may be cooler than the air from the day zone.

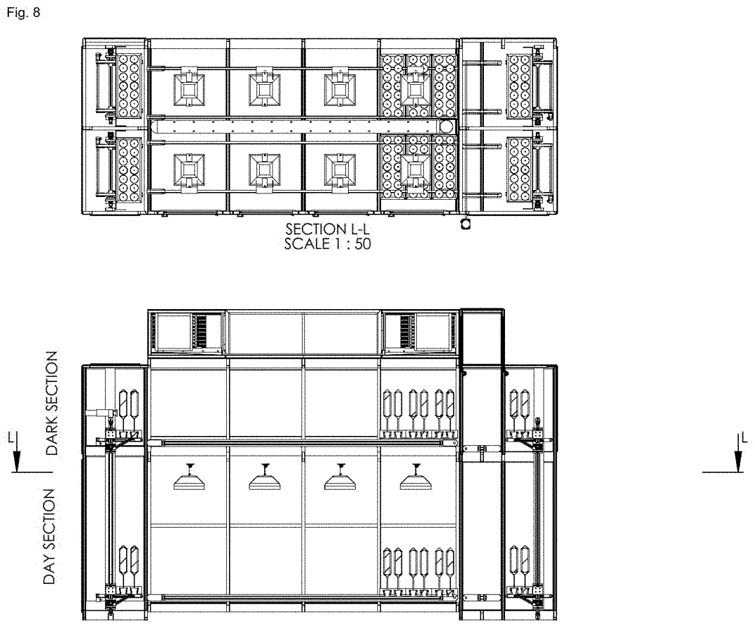

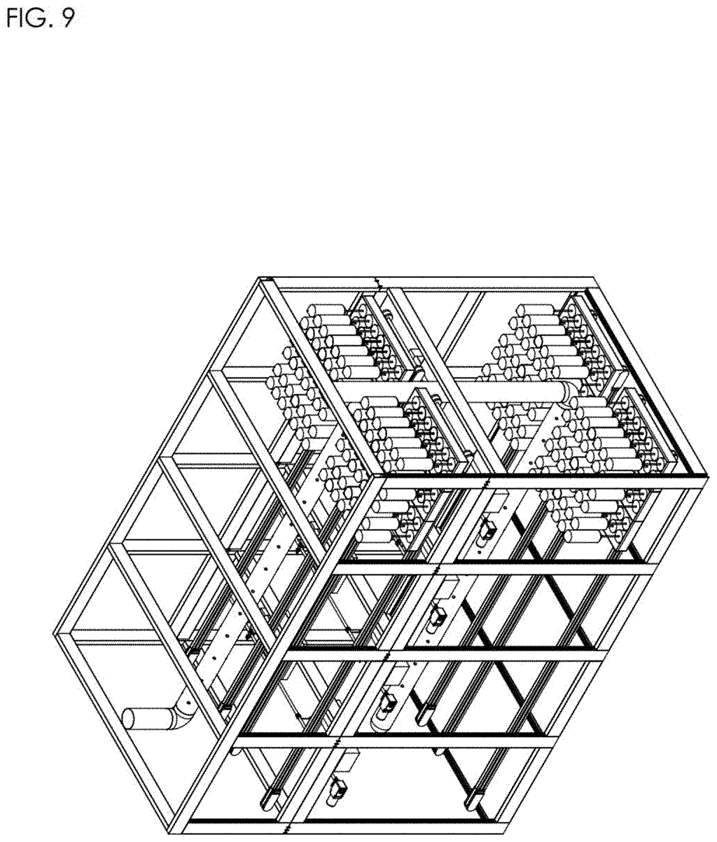

As shown in FIGS. 6 to 9, there are provided perspective and plan views of plants provided in the two growth zones. FIGS. 6 and 7 provide the embodiments of the present invention without the HVAC and other equipment shown in area 110. FIG. 8 provides a cross side view and plan view of an embodiment of the present invention, namely a plan view illustrating the lighting equipment provided in the day section. FIG. 9 provides a perspective view of apparatus 100 without the end portions and showing, only the dark and day sections.

Although this disclosure has described and illustrated certain preferred embodiments, as shown in FIG. 1, in a second situation, of the invention, it may be understood that the invention is not restricted to those particular embodiments. Rather, the invention includes all embodiments which are functional or mechanical equivalence of the specific embodiments and features that have been described and illustrated.

We claim:

1. An apparatus system for optimizing the growth of a plant, the apparatus comprising: (a) a climate controlled grow tunnel having a plurality of tiers, each tier having a plurality of plants disposed therein, each tier having separate climate controls such that a plurality of growing environments is provided within the growing apparatus; and (b) at least one access point providing an operator with access to the plurality of plants as they move through the growing apparatus.

2. The apparatus of claim 1 wherein the plants move horizontally through each tier and vertically between tiers.

3. The apparatus of claim 2 wherein the apparatus further comprises a first tier which provides the plant with constant light and a second tier that provides the plant with constant dark.

4. The apparatus of claim 3 wherein the grow tunnel provides that the plant is exposed to 18 hrs. of light in the first tier and 6 hrs. of darkness in the second tier.

5. The apparatus of claim 3 wherein the grow tunnel provides that the plant is exposed to 12 hrs. of light in the first tier and 12 hrs. of darkness in the second tier.

6. The apparatus of claim 5 wherein the first and second tier conditions are set at (a) a temperature range of 20° C.-25° C.; and (b) a humidity range of 50-65% R.H., each for two to three weeks before heading to flower.
